(19) United States
(12) Patent Application Publication
(10) Pub. No.: US 2019/0299747 A1
(43) Pub. Date: Oct. 3, 2019

(54) AIR INTAKE MANAGEMENT SYSTEM FOR THE FRONT FACE OF A MOTOR VEHICLE

(71) Applicant: VALEO SYSTEMES THERMIQUES, Le Mesnil Saint Denis (FR)

(72) Inventors: Jean-Louis LANARD, Le Mesnil Saint Denis (FR); Frédéric VACCA, Le Mesnil Saint Denis (FR); Enzo MITIDIERI, Le Mesnil Saint-Denis (FR)

(73) Assignee: Valeo Systemes Thermiques, Le Mesnil Saint Denis (FR)

(21) Appl. No.: 16/303,156

(22) PCT Filed: May 24, 2017
(86) PCT No.: PCT/FR2017/051305

§ 371 Date: Nov. 20, 2018

(30) Foreign Application Priority Data
Jun. 8, 2016 (FR) 1655226
Jun. 8, 2016 (FR) 1655227

(51) Int. Cl. B60H 1/22; B60K 11/08

(52) U.S. Cl. CPC B60H 1/2218; B60K 11/085

(57) ABSTRACT

The invention relates to an air management system for an air intake (2) on the front face of a motor vehicle, comprising at least one shutter (3), a frame for mounting said at least one shutter, and a device (10) for heating the at least one shutter (3) and/or the mounting frame.

The invention relates to an air management system for an air intake on the front face of a motor vehicle.

Such a system usually has at least one shutter and a movement control device for moving said at least one shutter between a closed position of the air intake and at least one open position of the air intake.

Such a system is most commonly referred to as an active grille shutter (AGS).

The air intake management system is preferably installed on a radiator grille of a motor vehicle.

When the air intake is in the open position, the air can flow through the radiator grille and notably help to cool the engine of the motor vehicle.

When the air intake is in the closed position, the air can no longer enter via the radiator grille, which reduces drag and thereby reduces fuel consumption and carbon dioxide emissions.

The air intake management system therefore helps to reduce energy consumption and pollution when the engine does not require cooling using outside air.

In a known manner, the air intake management system is exposed to the rain as well as to the water contained in the moisture in the air.

In particular, the water can accumulate at the bottom of the shutters or between the shutters.

In winter conditions and at sub-zero temperatures, it is not uncommon for water coming into contact with the management system to be deposited there and to freeze thereupon.

However, once frozen, the ice blocks the system in the current position, i.e. the shutter or shutters may be blocked in the closed position.

This results in the engine of the vehicle not being correctly cooled, which could lead to overheating and result in the motor vehicle breaking down.

A known solution involves keeping the shutter or shutters in the open position when the vehicle is stopped.

However, in this case neither the radiator of the engine nor the engine are insulated from the cold, which could result in the temperature increase of the radiator taking longer when the vehicle is started.

Consequently, the passenger compartment stays colder for longer, creating a certain discomfort for the passengers of the vehicle.

Furthermore, it takes longer to reduce friction in the engine, which increases fuel consumption by the vehicle, and therefore also carbon dioxide emissions.

The purpose of the invention is to at least partially overcome these drawbacks.

For this purpose, the invention relates to an air management system for an air intake on the front face of a motor vehicle, comprising at least one shutter, a mounting frame and a device for heating said at least one shutter and/or said mounting frame.

Consequently, even in sub-zero temperatures, the management system according to the present invention is de-iced and there is no risk of blocking in the closed position. The engine continues to be efficiently cooled even under these circumstances, which helps ensure reasonable fuel consumption by the vehicle.

According to another feature of the invention, the heating device has an electrical circuit that is designed to be powered by an electricity source and that passes through said at least one shutter and/or at least a portion of a mounting frame of said at least one shutter.

According to another feature of the invention, the system has at least one support provided with a bearing that is designed to receive a shaft of said at least one shutter, the electrical circuit electrically linking said at least one shutter to said at least one support.

According to another feature of the invention, said at least one shutter is made from an electrically conductive material.

According to another feature of the invention, the conductive material is either an electricity-conducting metal or an insulating substrate with an electrically charged surface, or a material comprising a metal wire overmoulded with a plastic material, or a polyamide- or polypropylene-based resin filled with conductive fibres.

According to another feature of the invention, the conductive material is a polyamide- or polypropylene-based resin filled with carbon fibres.

According to another feature of the invention, the polyamide- or polypropylene-based material filled with carbon fibres comprises 20% carbon fibres by mass.

According to another feature of the invention, the electrical circuit has a switch to close and open the circuit.

According to another feature of the invention, the system includes a timer for controlling the opening of the switch.

According to another feature of the invention, the heating device has an electricity source and the electricity source is a dedicated source for the electrical circuit or an electrical control unit of an actuator of the management system.

According to another feature of the invention, the heating device has an electrical circuit that is designed to be powered by an electricity source and that passes through at least a portion of the mounting frame of said at least one shutter.

According to another feature of the invention, the electrical circuit includes a metal wire rigidly connected to the mounting frame.

According to another feature of the invention, the metal wire is glued to or overmoulded on at least one portion of the mounting frame or rigidly connected to the mounting frame by a retaining member.

According to another feature of the invention, the heating device includes the electricity source, the electricity source being a dedicated source for the electrical circuit or an electrical control unit of an actuator of the management system.

According to another feature of the invention, the heating device has a circuit for a liquid fluid that passes through at least a portion of the mounting frame of said at least one shutter.

According to another feature of the invention, the heating device includes a liquid fluid tank to feed the liquid fluid circuit.

According to another feature of the invention, the heating device includes a heating radiator designed to heat the liquid fluid in the liquid fluid circuit.

According to another feature of the invention, the heating device includes a control unit for the heating radiator.

According to another feature of the invention, the heating device is rigidly connected only to the mounting frame of the shutters, using any rigid attachment means such as overmoulding or retaining clips, so as to simplify the heating device while providing effective de-icing of the shutters, the frost accumulating mainly at the bottom of the air intake management system around the shutter mounting frame.

The invention also relates to a heating assembly for a management system for an air intake comprising a management system for an air intake as described above and an electricity source, the electricity source being a battery of the motor vehicle.

The invention also relates to a method for heating at least one portion of a mounting frame of a management system of an air intake as described above, including a step of stopping the heating device if a measured temperature is greater than or equal to a threshold temperature value.

The invention also relates to a method for heating at least one shutter of the management system of an air intake as described above or at least one shutter of the management system of an air intake of the assembly as described above that is provided with a management system for an air intake as described above, including a step of closing the switch of the electrical circuit followed by a step of opening the switch after a pre-set closed time of the heating circuit, and/or if a measured temperature is greater than or equal to a threshold temperature value, and/or if a speed of the vehicle is greater than or equal to a threshold speed value.

According to another feature of the invention, the method includes a step of keeping the electrical circuit closed if a control parameter is in a given state referred to as the closed state.

According to another feature of the invention, the control parameter is a measured hygrometry rate, the closed state being reached when the measured hygrometry rate is greater than or equal to a threshold value.

Other features and advantages of the invention are set out in the description below. This description is purely illustrative and should be read with reference to the attached drawings, in which:

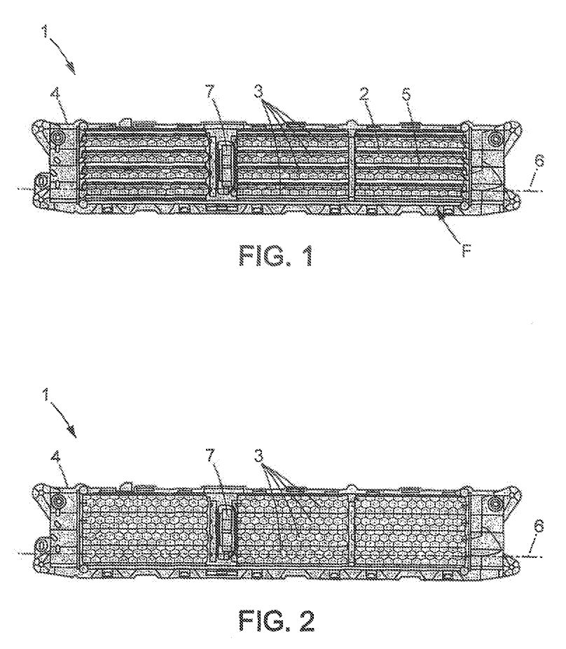

FIG. 1 is a front view of an air intake management system according to the present invention in a first position,

FIG. 2 is a front view of an air intake management system according to the present invention in a second position,

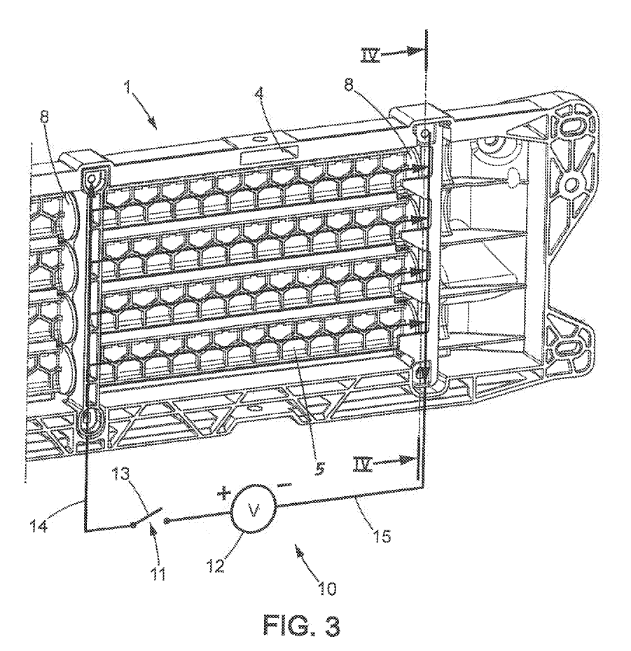

FIG. 3 is a detailed view of a rear face of a first management system in FIG. 1, and

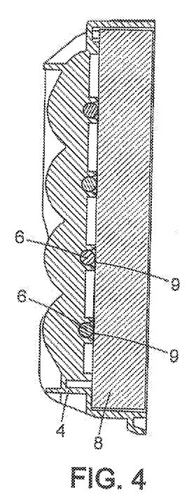

FIG. 4 is a cross-section view taken along the line IV-IV of the management system in FIG. 3,

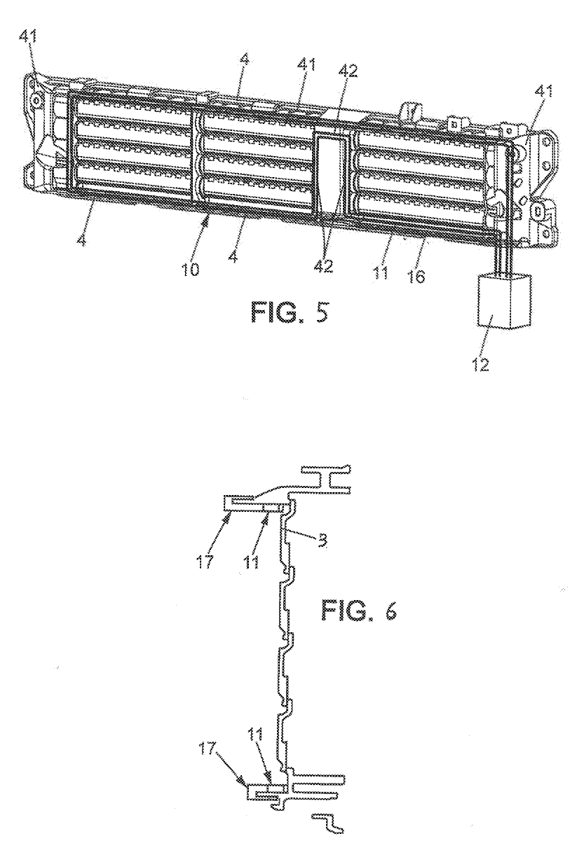

FIG. 5 is a detailed view of a front face of a second management system in FIG. 1 according to a first embodiment,

FIG. 6 is a transverse cross-section view of the second management system in FIG. 5 according to a variant embodiment, and

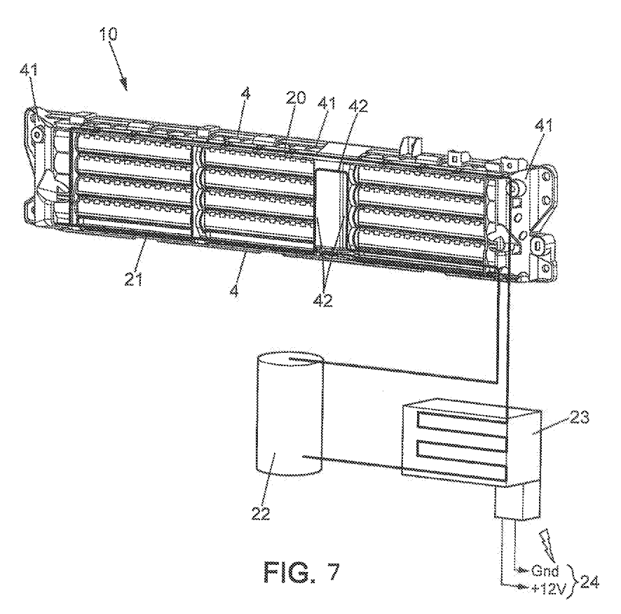

FIG. 7 is a detailed view of a front face of the second management system according to a second embodiment.

### AIR MANAGEMENT SYSTEM FOR AN AIR INTAKE

The invention relates to an air management system for an air intake on the front face of a motor vehicle.

The system is most commonly referred to as an active grille shutter (AGS).

The air intake management system is preferably installed on a radiator grille of the motor vehicle and enables control of the air flow flowing through the front face of the vehicle, including an engine compartment of the vehicle.

In the figures, the management system is indicated using reference sign 1, while the air intake managed by the management system 1 is indicated using reference sign 2.

As shown in FIGS. 1 and 2, the management system 1 for an air intake 2 includes at least one shutter 3.

In the embodiment shown, the management system 1 has a plurality of shutters 3.

As shown in FIGS. 1 and 2, the management system 1 also has a mounting frame 4 that is preferably rigid and is rigidly connected to the plurality of shutters 3.

The frame 4 has an overall rectangular shape.

The frame 4 delimits the air intake 2 that the shutters 3 open and close, as detailed below.

In the installed position in the motor vehicle, the frame 4 is designed such that the lengths of the rectangle extend substantially horizontally and the widths of the rectangle extend substantially vertically.

In FIG. 1, the shutters 3 are divided into three sets of four shutters.

In each set, the shutters 3 are arranged in parallel and beneath one another, and the three sets are arranged as an extension of one another.

Naturally, the invention is not limited to the embodiment illustrated, and in particular the number of shutters, sets of shutters and the positions of the shutters in relation to one another can be changed.

Each shutter 3 has a working surface 5.

For example, the working surface 5 is a panel with an overall flat rectangular shape.

Naturally, the invention is not limited to flat rectangular shutters, and other shapes are entirely possible.

Each shutter 3 has a shaft 6 rigidly connected to the working surface 5.

In FIGS. 1 and 2, the shafts 6 extend substantially horizontally.

Each shutter 3 is mounted pivotingly between a closed position of the air intake 2 and at least one open position of the air intake 2.

To do so, the system 1 has two supports 8 provided with cut-outs forming bearings 9, each bearing 9 being designed to receive one end of the shaft 6 of one of the shutters 3, as illustrated in FIG. 4.

The ends of the shafts 6 are mounted pivotingly in the related bearing 9, which enables the working surface 5 to pivot between the closed position, also referred to as the blocked position, and the open position or positions.

When one of the shutters 3 is in the closed position, the working surface 5 covers a portion of the air intake 2.

In each open position, the working surface 5 forms a non-zero angle with a virtual flat surface of the air intake 2, which enables an airflow to pass through the air intake 2.

As shown in FIGS. 1 and 2, the management system 1 also includes a control device 7 for moving the shutter or shutters 3.

The control device 7 is advantageously an actuator.

According to the variant embodiment illustrated, a single actuator 7 controls all of the shutters 3.

The system 1 also includes a control rod for the shutters (not shown) that is controlled by the actuator 7 via a lever (not shown).

As shown in FIG. 1, when the shutters 3 are in the open position, the air intake 2 is traversed by an air flow.

This position is particularly advantageous when the engine of the vehicle require significant cooling.

In FIG. 2, the air intake 2 is completely closed by the working surfaces 5.

This position is particularly advantageous when the vehicle is travelling at high speed, since closing the air intake 2 improves the aerodynamics of the motor vehicle, thereby helping to reduce fuel consumption.

In this regard, the shutters 3 can be qualified as drag coefficient reduction shutters.

### First Heating Device

As shown in particular in FIG. 3, the management system 1 includes a heating device for the shutters 3.

The heating device has an electrical circuit 11, referred to as the heating circuit, that is designed to be powered by an electricity source 12 and that passes through at least one shutter 3 and/or at least a portion of a mounting frame 4.

Preferably, the electricity source 12 is a reliable and continuous voltage or current source, for example of a few milliamps or a few volts.

The electricity source 12 powers the circuit 11 at least when the vehicle is started, as detailed below.

In the embodiment illustrated, the heating circuit 11 passes through each shutter 3.

As shown in FIG. 3, the heating circuit 11 has a switch 13 for opening and closing the heating circuit 11.

Advantageously, the system 1 includes a timer for controlling the opening of the switch 13 (not shown), the operation of which is detailed below.

As shown in FIG. 3, the heating circuit includes an electrical wire forming a first branch 14 between the electricity source 12, the switch 13 and the first support 8 and an electric wire forming a second branch 15 between the second support 8 and the electricity source 12.

### Composition

Advantageously, the shutters 3 and/or the mounting frame 4 are made of an electrically conductive material.

According to a preferred embodiment, the shutters 3 are made of an electrically conductive material while the mounting frame 4 is made of and electrically insulating material.

In this case, the current is maintained in the shutters 3, with the frame 4 enabling electrical insulation.

According to a preferred variant, the shutters 3 are made of a polypropylene-based resin filled with conductive fibres, advantageously carbon.

Advantageously, the polypropylene-based material filled with carbon fibres comprises 20% carbon fibres by mass.

Polypropylene with carbon fibres ensures good rigidity of the shutters while reducing the weight thereof, which helps to reduce vehicle fuel consumption.

According to another variant, the shutters 3 are made of an electricity-conducting metal material, such as steel, aluminium or chrome.

According to one variant, the shutters comprise an insulating substrate that has undergone a surface treatment so that the surface is electrically charged, for example polyaniline coating. This polymer can also be used to manufacture heating coatings, notably using a Joule-effect heating method to accelerate polymerisation of thermosetting resins.

Polyaniline can also be incorporated into the plastic in powder form, thereby forming an electrically conductive filling.

According to another variant, the shutters 3 comprise a metal wire overmoulded with a plastic material.

Advantageously, the overmoulded metal wire passes through the shafts 6 and/or the edges of the shutters 3.

### Variants not Shown

According to the embodiment illustrated, the heating device 10 has an electricity source 12, the electricity source 12 being a dedicated source for the heating circuit 11.

However, the invention is not limited to this embodiment.

In particular, according to another variant, the electricity source is an electrical control unit for the actuator 7.

In this case, the rod and the lever linking the shutters 3 to the actuator 7 are advantageously made of a conductive material, for example polypropylene with carbon fibres, in order to ensure that the electrical circuit 11 extends from the control unit to the shutters 3 via the rod and the lever.

The invention also relates to a heating assembly (not shown) including the management system 1, the electricity source 12 being a battery of the motor vehicle.

According to another variant that is not shown, the heating circuit 11 can pass exclusively through the frame 4. Heating the frame 4 enables the indirect heating of the shutters 3, in particular the shutters 3 in contact with the frame 4 in the closed position.

### Heating Method

The invention also relates to a heating method for at least one shutter 3 of the system 1.

The method includes a step of closing the switch of the heating circuit 11, for example when the vehicle is started.

During the closing step, the electricity source 12 powers the circuit 11 and an electric current passes through the heating circuit 11 via the first branch 14, the first support 8, each of the shutters 3, the second support 8 and the second branch 15.

The electric current causes the shutters to heat up gradually, which enables same to be gradually de-iced.

Preferably, the method also includes a step of opening the switch 13.

For example, the opening step takes place after a pre-set closed time t of the heating circuit.

The time t is for example around a few minutes, for example around five minutes.

In a variant, the opening step takes place if a temperature measured by a sensor is greater than or equal to a threshold temperature value, referred to as the threshold temperature.

Preferably, the sensor is arranged on the front face of the vehicle and the threshold temperature is for example around 3° C.

As a variant or in a combination, the opening step takes place if a speed of the vehicle is greater than or equal to a threshold speed value, referred to as the threshold speed.

The threshold speed is for example around 50 km/h.

It is also possible for the measured temperature to be the temperature of a radiator of the engine of the vehicle.

In this case, the opening step takes place if the temperature measured is greater than or equal to 90°.

Furthermore, the closing step may last for at least the pre-set time t, taking the temperature and speed parameters into account once the time t has expired.

Advantageously, the heating method includes a step of keeping the heating circuit closed if a control parameter is in a given state referred to as the closed state.

This step of keeping the heating circuit closed ensures that the shutters are heated continuously in specific conditions.

Preferably, the control parameter is a measured hygrometry rate, the closed state being reached when the measured hygrometry rate is greater than a threshold value.

In this case, the shutters are heated as long as the vehicle is in the rain.

### Benefits

As specified above, the management system according to the present invention and the related heating method ensure that the shutters are de-iced, thereby reducing the risk of the shutters getting blocked in the closed position while ensuring that the engine compartment is insulated when the vehicle is stopped.

### Second Heating Device

As shown in particular in FIG. 5, the management system 1 includes a heating device 10 for the mounting frame 4.

Heating the frame 4 enables the indirect heating of the shutters 3, in particular the shutters 3 in contact with the frame 4 in the closed position.

Thus, the heating device 10 can also be qualified as a heating device for the shutters 3.

### First Embodiment

The heating device 10 has an electrical circuit 11, referred to as the heating circuit, that is designed to be powered by an electricity source 12 and that passes through at least a portion of a mounting frame 4.

Preferably, the electricity source 12 is a reliable and continuous voltage or current source, for example of a few milliamps or a few volts.

The electricity source 12 powers the circuit 11 at least when the vehicle is started, as detailed below.

According to the embodiment illustrated, the electricity source 12 is a dedicated source for the heating circuit 11.

However, the invention is not limited to this embodiment.

In particular, according to another variant, the electricity source is an electrical control unit for the actuator 7.

In the embodiment illustrated, the heating circuit 11 passes through the four edges 41 of the mounting frame 4 and the edges 42 of the actuator 7.

As shown in FIG. 5, the electrical circuit 11 includes a metal wire 16 rigidly connected to the mounting frame 4.

According to a first variant, the metal wire 16 is rigidly connected to the mounting frame 4 by gluing.

For example, the metal wire can be contained in a sticker that need simply be stuck to the mounting frame 4.

In a second variant, the metal wire 16 is overmoulded with a plastic material forming at least the mounting frame 4.

According to a third variant illustrated in FIG. 6, the system 1 includes a retaining member 17 to hold the metal wire 16 on the mounting frame 4.

In FIG. 6, the retaining member 17 is a clip locking means, made for example of an elastomer.

According to the first embodiment illustrated, the heating device 10 has an electricity source 12, the electricity source 12 being a dedicated source for the heating circuit 11.

However, the invention is not limited to this embodiment.

In particular, according to another variant, the electricity source is an electrical control unit for the actuator 7.

### Second Embodiment

As shown in FIG. 7, the heating device 10 includes a liquid fluid circuit 20, the circuit 20 passing through at least one portion of the mounting frame 4.

Advantageously, the liquid fluid is water.

In the embodiment illustrated, the liquid fluid circuit 20 passes through the four edges 41 of the mounting frame 4 and the edges 42 of the actuator 7.

The circuit 20 has a set of channels 21.

The channels 21 are made of a heat conducting material.

The channels may for example be aluminium tubes.

According to a variant, the channels 21 are built into a plastic material forming the mounting frame 4.

According to another variant, the channels 21 are welded to the mounting frame 4.

As shown in FIG. 7, the heating device includes a tank 22 of liquid fluid to feed the liquid fluid circuit, the liquid fluid being for example a mixture of antifreeze and water.

According to a variant, the tank 22 is dedicated to the liquid fluid circuit 20.

According to another variant, the tank 22 is connected to a cooling circuit of the engine of the motor vehicle.

As shown in FIG. 7, the heating device 10 includes a heating radiator 23 for the liquid fluid intended to flow in the liquid fluid circuit.

The heating device also includes a control unit 24 for the heating radiator 23.

### Heating Method

The invention also relates to a heating method for at least one shutter 3 of the system 1.

The method includes a step of heating the frame 4 and the shutters 3 using the electrical circuit 11 or the liquid water circuit 20.

Thus, the shutters are gradually heated, which enables same to be gradually de-iced.

Preferably, heating is stopped if a temperature measured by a sensor is greater than or equal to a threshold temperature value, referred to as the threshold temperature.

For example, the sensor is arranged on the front face of the vehicle and the threshold temperature is for example around 3° C.

### Benefits

As specified above, the management system according to the present invention and the related heating method ensure that the shutters are de-iced, thereby reducing the risk of the shutters getting blocked in the closed position while ensuring that the engine compartment is insulated when the vehicle is stopped.

1. An air management system for an air intake on the front face of a motor vehicle, comprising:
at least one shutter;
a frame for mounting said at least one shutter; and
a heating device for heating said at least one shutter and/or said mounting frame.

2. The air management system for an air intake according to claim 1, wherein the heating device has an electrical circuit that is designed to be powered by an electricity source and that passes through said at least one shutter and/or at least a portion of a mounting frame of said at least one shutter.

3. The air management system for an air intake according to claim 2, wherein the system has at least one support provided with at least one bearing that is designed to receive a shaft of said at least one shutter, the electrical circuit electrically linking said at least one shutter to said at least one support.

4. The air management system for an air intake according to claim 1, said at least one shutter is made from an electrically conductive material.

5. The air management system for an air intake according to claim 4, wherein the conductive material is either an electricity-conducting metal or an insulating substrate with an electrically charged surface, or a material comprising a metal wire overmoulded with a plastic material, or a polypropylene-based resin filled with conductive fibres.

6. The air management system for an air intake according to claim 5, where the conductive material is a polypropylene-based resin filled with carbon fibres.

7. The air management system for an air intake according to claim 6, wherein the polypropylene-based material filled with carbon fibres comprises 20% carbon fibres by mass.

8. The air management system for an air intake according to claim 2, wherein the electrical circuit has a switch to close and open the circuit.

9. The air management system for an air intake according to claim 8, including a timer for controlling the opening of the switch.

10. The air management system for an air intake according to claim 2, wherein the heating device has an electricity source, the electricity source being a dedicated source for the electrical circuit or an electrical control unit of an actuator of the management system.

11. The air management system for an air intake according to claim 1, wherein the heating device has a circuit for a liquid fluid that passes through at least a portion of the mounting frame of said at least one shutter.

12. A heating assembly comprising
a management system for an air intake according to claim 2; and
an electricity source comprising a battery of the motor vehicle.

13. A method for heating at least one shutter of a management system for an air intake according to claim 8, the method comprising:
closing the switch of the electrical circuit followed by a step of opening the switch after a pre-set closed time of the heating circuit, when a measured temperature is greater than or equal to a threshold temperature value, or when a speed of the vehicle is greater than or equal to a threshold speed value.

14. The method according to claim 13, further comprising of keeping the electrical circuit closed when a control parameter is in a given state referred to as the closed state.

15. The method according to claim 14, in which the control parameter is a measured hygrometry rate, the closed state being reached when the measured hygrometry rate is greater than or equal to a threshold value.
